(19) United States
(12) Patent Application Publication
(10) Pub. No.: US 2009/0218209 A1
(43) Pub. Date: Sep. 3, 2009

(54) Thermolysis of organic waste in a ball furnace

(76) Inventors: Gerard Poulleau, Marcigny (FR); Pascal Colignon, Soissons (FR); Francois Hustache, Andresy (FR)

Correspondence Address: SUGHRUE MION, PLLC, 2100 PENNSYLVANIA AVENUE, N.W., SUITE 800, WASHINGTON, DC, 20037, US

(21) Appl. No.: 11/659,123

(22) PCT Filed: Jul. 29, 2004
(86) PCT No.: PCT/FR04/02032

§ 371 Date: Dec. 10, 2008

(30) Foreign Application Priority Data
Aug. 4, 2003 (FR) 0309592

(51) Int. Cl. B09B 3/00

(52) U.S. Cl. 201/10

(57) ABSTRACT

The method is characterised in that the thermal energy necessary for thermolysis of the waste carried out in the absence of air is provided by a heating mass, comprising steel balls (9), running in the furnace (1) co-currently with the waste. The method may be applied to household waste, sewage work residues, hospital wastes, wastes of risk to the agro-food industry and in a general manner to all wastes containing organic matter be it of urban, agricultural or industrial origin.

### TECHNICAL DOMAIN

The invention relates to the treatment of organic waste consisting of industrial waste, agricultural waste or household waste. It relates to their transformation by thermolysis, and particularly by thermolysis taking place in an installation in which a fixed or rotating furnace is installed.

Waste elimination operations are performed in a context of reuse and preservation of the environment. Thermolysis is a waste elimination process that offers an alternative to incineration, over which it has many advantages (no emission of dioxins, no production of ash contaminated by organic compounds, excellent operating flexibility). A good presentation of the question is given in the “Report on new technologies for reuse of household waste and non-hazardous industrial waste”, Parliamentary Office for the Evaluation of Scientific and Technological Choices, France, National Assembly No. 1693/Senate, No. 415, G. Miquel and S. Poignant (Part II: treatment processes, III: Thermolysis), and in G. Poulleau, ‘Household waste’, Air Eau Conseil edition, 2001.

### PRIOR ART

Thermolysis consists of a chemical decomposition by heating organic matter in any form whatsoever (liquid, paste or solid) in the absence of air. It is done continuously or discontinuously by increasing the temperature of the organic matter to 400° C. to 700° C., or possibly even 1100° C. when the objective is to treat risk waste in a fixed or rotating containment in the absence of air. (The term ‘risk waste’ should be understood to have the meaning defined by the lawmaker, particularly including bovine parts that could contain prions, BSE propagation agents). The production of charcoal, that is usually referred to as pyrolysis, is a thermolysis. Pyrolysis has been used for many years in the past for the reuse of household waste (DE 29040324, Berghoff).

Regardless of the production process, thermolysis transforms organic substances into products that can be reused in different ways:
gases burned on the production site, for example as a heat source for the thermolysis itself;
condensates, for which the oil fraction can be exported as a fuel;
solid residue firstly including a coke, exportable as a fuel after reprocessing, and a mineral fraction that can be reused or eliminated in accordance with the legislation in force, depending on the nature and characteristics of the organic matter being treated.

The mass to be thermolysed is heated by various means, including direct action of a radiant flame inside the containment, circulation of fumes or combustion gases through the mass of waste to be thermolysed, contact with internal tubes, external heating of the containment. There are many descriptions of thermolysis installations, for example in patents FR 2654112 (CGS), FR 2725643 (Traidec).

Direct heating of the matter with a hot combustion gas is a technique that has serious disadvantages. Combustion gases usually produced with the thermolysis gas contain large quantities of oxygen. Producing a flame in a containment in which it is required to thermolyse the waste requires that the quantity of air in the flame should be increased so as to maintain this flame and its temperature that inevitably drops in a reducing medium. 100% to 200% excess air is frequently observed under these conditions, and consequently the excess air and particularly the oxygen in this air will combine with molecules containing chlorine (for example) to produce dioxins and also all other sorts of combinations that denature the thermolysis products. Other disadvantages should be mentioned, particularly lowering of the net calorific value (NCV) of the gas output from the thermolysis containment, and the obligation to treat non-recycled fumes particularly to eliminate unburned products following burning of a gas containing fumes. This is true for all waste destruction processes that take place in the presence of air, such as the De Muynck process described in U.S. Pat. No. 5,762,010 that is related to a fluidised bed combustion process in which the waste entrained by ceramic balls is burned completely in the same containment after having been partially pyrolysed under the effect of heat released by this combustion.

External heating of the containment requires large heat exchange surface areas, and a relatively long residence time of organic matter in the containment; the thermal efficiency is affected by the loss of calories in the fumes; overheating of the walls causes them to collect dirt more or less quickly on the inside, and catalytic or mechanical cleaning systems are more or less efficient at cleaning them during compulsory shutdowns.

Heating tubes internal to the furnace are very sensitive to degradation by badly shredded scrap, inevitably added sooner or later with the waste to be treated. No waste thermolysis processes are capable of reaching temperatures greater than 700° C., unless a flame is applied in direct contact, like in an incineration process. Consequently, it is impossible to offer satisfactory solutions for some waste such as hazardous waste from bovine slaughterhouses or healthcare waste.

### PRESENTATION OF THE INVENTION

This invention overcomes these disadvantages with an organic waste thermolysis process that consists of adding the heat necessary for heat treatment of this waste using previously superheated steel balls.

For the purposes of this invention, the term ‘organic waste’ applies to different solid, semi-paste or paste bodies containing a certain proportion of organic matter. The following is a non-limitative list of such matter:

rottable fraction of household waste,

sludge from industrial effluent and urban sewage treatment plants,

farm waste, composting refuse,

organic matter from the agro-food industry (grease, slaughterhouse waste including risk waste, animal flour, etc.),

non-reusable industrial organic matter,

used non-retreadable shredded tires,

healthcare waste,

in general, all waste containing organic matter which, if the legislation is respected, can no longer be buried as such or incinerated. Note that the existing legislation does not allow burial of hazardous industrial waste unless its total organic carbon content is less than 3 grams per kg; this demonstrates the advantage of processes like the process according to the invention that is capable of eliminating all organic carbon in waste with low organic content such as sand contaminated by hydrocarbons or phenols.

This definition is also applicable to organic liquids that can be distributed on the balls as a coating, or possibly mixed beforehand with absorbent organic supports, for example vegetable waste or sawdust.

Also according to the meaning of this invention, ‘thermolysis’ means heat treatment in the absence of air leading to physical and chemical transformation of the thermolysed matter with the release of condensable or incondensable volatile products and the formation of a solid carbonaceous residue (coke). This is a genuine thermolysis, which can only take place in complete absence of air. This is how the process is different from a combustion or partial thermolysis waste treatment.

Using these definitions, the invention consists of a process for heat treatment of organic waste in an oxygen-free atmosphere, in which the waste is heated in a fixed or rotating furnace, characterised in that the means of heating the said waste consists of previously superheated steel balls and that move forwards in the furnace at the same time as the said waste with which they are intimately mixed. It also consists of an installation for the heat treatment of organic waste comprising at least one fixed or rotating furnace in which waste moves forwards during its treatment, means of supplying the furnace with waste, means or recuperating the treated waste, means of recuperating volatile products derived from this treatment and means of heating the waste mass, characterised in that the means of heating the waste mass consists of a mass of previously superheated steel balls that move inside the furnace with the waste to be treated, and devices for supplying the furnace with superheated balls, for recuperating them at the exit from the treatment furnace so that these balls can be recirculated, and a furnace for heating the balls.

### FIGURES AND REFERENCES

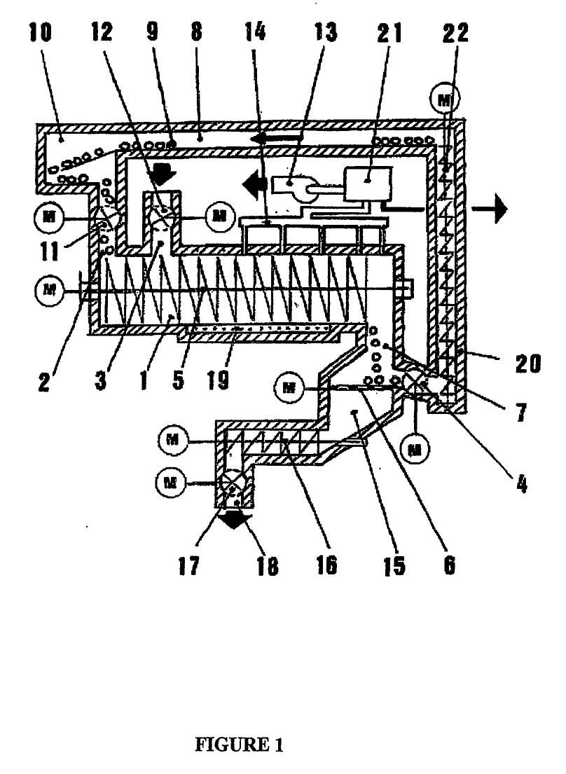

The general structure of a thermolysis group according to the invention is shown diagrammatically in FIG. 1, wherein:
(1) Thermolysis furnace;
(2) Entry duct for balls heated to high temperature;
(3) Inlet duct for waste to be thermolysed;
(4) Exit drum or lock for balls that have released their thermal energy;
(5) worm screw;
(6) Vibrating grating to separate the balls from thermolysis residue;
(7) Exit duct for the mix of balls from thermolysis residue;
(8) Duct for recirculating steel balls;
(9) Steel balls;
(10) Steel ball heating furnace;
(11) Steel ball entry drum or lock;
(12) Entry drum or lock for material to be treated;
(13) Vacuum pump extraction fan for suction of thermolysis gases and for keeping a slight negative pressure in the furnace;
(14) Manifold (thermolysis gas for reuse as energy; sludge for condensation and extraction of incondensables to be burned);
(15) Thermolysis residue recuperation hopper;
(16) Thermolysis residue transfer screw;
(17) Evacuation lock or drum for thermolysis residue;
(18) Thermolysis residue evacuation duct;
(19) Makeup heating to compensate for furnace losses or adding energy during start up phases;
(20) Insulation of the furnace, ducts, hopper, etc. assembly;
(21) Vacuum condensation assembly, recuperation of thermolysis condensables;
(22) Device for lifting the heating mass (screw, belt, etc.);
(M) are motors.

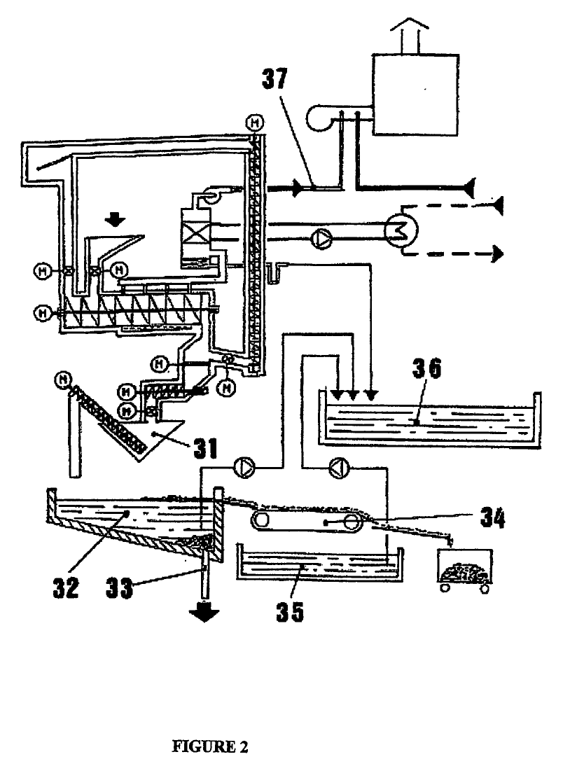

FIG. 2 shows a specific thermolysis unit; the following elements can be seen, that are complementary to the elements shown in the general FIG. 1:
(31) Thermolysis residue storage hopper;
(32) Thermolysis residue washing tank;
(33) Solid residue evacuation duct;
(34) Coke dripping belt;
(35) Coke drip storage and recovery tank;
(36) Storage tank for all liquid effluents, condensates, coke drips, dirty water from the washing basin and separation of thermolysis residue;
(37) To use of thermolysis gases.

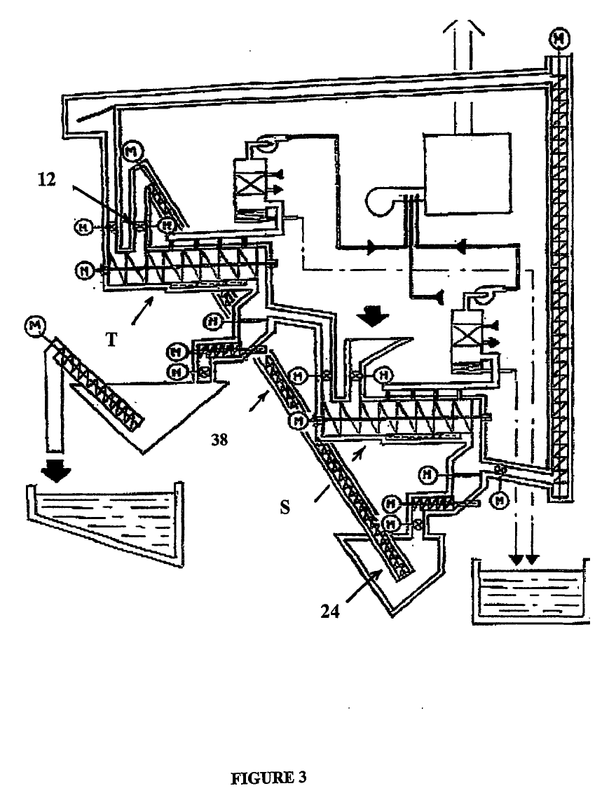

FIG. 3 shows a diagram of an installation that could collect waste with variable humidity, that comprises a drying furnace and a thermolysis unit in series. It includes the elements indexed on the previous figures around:
(S) the drying furnace;
(T) the thermolysis furnace;
(24) a buffer hopper for storage of dried waste;
(38) an elevator between the hopper (24) and the thermolysis furnace inlet duct (3).

### PRODUCTION OF THE INVENTION

Characteristically, the heating mass in the process is composed of a large quantity of steel balls, usually balls with a diameter of 20 to 50 millimetres. Larger diameter balls can be used to treat special contents, for example with a diameter of 60 millimetres to thermolyse ground tyres or long-fibre waste. The choice of steel balls provides a solution to some technical constraints, particularly fast transfer of heat at high temperatures, optimisation of exchange surface areas within the small volume of the thermolysis furnace, mechanical disintegration of the organic matter as soon as it enters the furnace, and coke at the end of the path. The content of balls in terms of mass and diameter is determined as a function of the powers to be used, and the free volume within the heating mass; there are other criteria such as their manipulation or handling during recirculation and particularly during transit in drums, and the concern to avoid deformations in the thermolysis containment when they drop in at the entry to the device. Example 1 contains information useful for estimating their content. Their apparent density is high compared with the matter to be treated and is of the order of 4000 kg/m³ to 4500 kg/m³. The developed surface area of the heating mass compared with its volume is very high, such that heat will be uniformly distributed in the waste mass when it is mixed with the matter to be treated. This special feature is particularly appreciable when the objective is heat treatment of hazardous waste: temperatures as high as 1100° C. are essential for total destruction of protein material and therefore prions only in installations in which the thermolysis temperature is not uniform.

The furnace in which heat treatment of the waste takes place is a horizontal or slightly inclined furnace. When the power to be applied is relatively modest and the mass to be treated is not much more than 500 kilograms/hour, the furnace in which the heat treatment of the waste takes place is preferably a fixed furnace in which the balls+waste mass moves forward under the action of a worm screw (5) fitted with mixing devices (for example profiled bars). This is the embodiment that has been used as a descriptive example for the figures, although this in no way restricts the scope of the invention. For high capacities, the furnace will more often be a traditional furnace equipped with a balls and waste pre-mixing device at the ball and waste entry.

Makeup heating (19) is provided, if only for preheating of the furnace when the installation is started up; it occasionally fulfils various functions; maintaining the exit temperature of the steel balls, makeup when changing conditions (flow of materials, rise in the thermolysis temperature, drying, etc.).

All entry and exit drums and locks for materials are air tight by construction. In practice, they are provided with pressure balancing units to neutralise the inside volume of the drum and the waste supply or the exit of solid thermolysis products is made through a cascade of hoppers with automatic filling. All rotating parts, bearings in the rotating furnace, the shaft of the Archimedes screw and the ball and solid lifting and transfer screws are also made impermeable to air, for example by installing the motors and bearings in sealed cages.

The process operates as described below (refer to FIGS. 1 and 2). Waste penetrates into the thermolysis furnace (1) through the inlet duct (3) and the drum (12) and they meet the steel balls inlet at the top through the duct (2) and the drum (11) from a heating furnace (10) in which their temperature was increased to the order of 600° C. to 1100° C.

Thermolysis takes place during mixing of the waste and balls as the materials move forwards in the furnace (7). Materials leaving the furnace are now composed of cooled balls and thermolysis residue. Their temperature is then between 500° C. and 850° C. The thermolysis residue is extracted through the grating (6), collected in a recuperation hopper (15) and taken, outside through an extraction system (16) and a lock (17) and duct (18). Balls are recovered through the drum (4), returned through the elevator (22) and sent through the duct (8) to the furnace (10) where they resume their cycle.

Thermolysis gases are captured by a manifold (14), separated from their condensable components (21) and extracted in (13) to be burned or to supply gas turbines on site.

The installation (FIG. 2) is completed with elements that were listed with reference to FIG. 1 and with which those skilled in the art are familiar. (32) is the equipment for compulsory treatment of the thermolysis residue, immersion to separate a floating combustible material (coke) by dripping (34), solid residue by settlement (33) including metals that can be separated for example by metallic sorting or by Eddy currents, and immersion and dripping water (35) to be sent to a storage tank (36) for a depollution treatment. The settled sludge (33) will be treated or conditioned before evacuation to a specialized burial centre or for reuse if the final product is acceptable.

Thermolysis gases can be used on site (37).

The waste increases in temperature very suddenly on contact with the steel balls, which facilitates production of gas instead of coke. Gases released at high temperature then remain in contact with the heating mass for long enough to crack greases and other heavy molecules generated in some types of waste: a thermolysis gas with an optimised calorific value is produced, therefore the collection of dirt in the installation is reduced.

Steel balls are heated in a gas, electrical radiation or induction furnace (10). If a gas furnace is used, it is advantageous to use thermolysis gas drawn off from production at a percentage varying between 10% and 15%, so that 85% to 90% of gases will be available for external reuse as energy. The simplest process is a bare flame furnace, in which the atmosphere is isolated from the remaining atmosphere in the installation by sealed drums, as described above, to prevent the ingress of excess air from the flame into the thermolysis furnace. Heating of balls by induction is one particularly elegant variant, and is possible due to the metallic nature of the balls.

Since the process is simple and safe in use and operation in continuous or semi-continuous mode, very modest sized installations can be set up in the locations in which waste is produced; they enable the waste producer to destroy his own waste and recover excess energy for his own purposes in the form of hot water, steam or electricity.

For some applications in which power and flow variations can occur, a storage hopper can be used for the heated balls on the inlet side of the drum (11). Furthermore, this hopper can be used as a reactor for cracking thermolysis gases, for example if the waste is liquefied grease.

As soon as the water content of the waste to be thermolysed is high, the vaporisation of water becomes a limiting factor for the thermolysis procedure and it is better to dehydrate this waste in advance. The invention is particularly conducive to such dehydration even within the installation, at least if the initial dryness (content of dry matter) is greater than 35%. (Below 35%, thermolysis would require an external input of calories and it is more reasonable to apply an external mechanical treatment requiring much lower energy to this matter containing larger quantities of water).

This is shown diagrammatically in FIG. 3. The installation then comprises two furnaces of the same type in series, the thermolysis furnace (T) and the drying furnace (S). The same heating mass of steel balls transits in these two furnaces and firstly thermolyses the dried waste and then dehydrates the wet waste. The wet waste enters into the drying furnace (S) and then passes directly into the thermolysis furnace (T). The hot heating mass firstly enters into the furnace (T) where it thermolyses its content; its temperature is still sufficiently high at the exit from the thermolysis furnace to apply partial preliminary drying of the waste in the furnace (S). An elevator (38) picks up the dried waste at the hopper (24) and takes it to the thermolysis furnace waste inlet lock (12). A gas and drying sludge collection device is provided on the furnace (S) that directs it towards the thermolysis gas burner.

Obviously, the installation according to the invention could be used as a simple material drying installation. Such drying, although not very conventional, has several advantages, namely that since it is done in the absence of air, it does not form any dangerous oxidation products; and since it makes direct contact between the matter to be dried and the heating mass, the necessary energy is transmitted to the core of the matter causing a fast and uniform increase in its temperature and prevents its agglomeration. Differences between a thermolysis group and a drying group according to the invention are minimal and take account of inlet and outlet temperatures of the heating mass,
in thermolysis, 600° C. to 1100° C. at the inlet, 500° C. to 850° C. at the outlet for gases and residue,
in drying, 500° C. to 600° C. at the inlet, 120° C. to 140° C. at the outlet of the dry waste,

for example, such that the condensation assembly (21) is used for condensation of vapours to extract incondensables to be burned in a boiler, or the extraction fan (13) is used for drawing in vapours from drying.

The thermal shock at the inlet is insufficient to prevent any risk of prions being entrained in the vapours for high risk waste.

Other uses could be envisaged for the installation with a steel ball furnace (sterilisation, baking, etc.), that remain within the scope of this invention.

The following non-limitative examples illustrate the invention.

### Example 1

A continuous thermolysis installation treating 800 tonnes annually (namely about 100 kg per hour) of waste after being previously dried to reduce the water content to 5%, and titrating 70% organic matter (average composition), is arranged around a 0.7 m diameter tubular reactor with a total length of 7.2 m.

Energy needs for the thermolysis determined by preliminary tests are 50 kWh for 100 kg of waste (excluding thermal losses). The average thermolysis temperature is fixed at 600° C.

The heating mass is composed of 20 mm diameter steel balls, the mass of which is estimated as follows.

With an average specific heat of steel equal to 0.174 W/kg/° C., the heating mass transferring its heat from 700° C. to 500° C. is 50 000/(0.174×200)=1437 kg, in other words 44 000 20 mm diameter balls (32.65 g per ball).

The installation produces gas at a rate of about 70 kg per hour capable of generating about 600 kWh, and 25 kg of solid residue.

### Example 2

The same installation can be used to process butcher's waste. It guarantees thermolysis throughout the mass at a temperature of 700° C., and possibly 900° C. for hazardous waste, the temperature at which all proteins, including any prions are destroyed.

The possibility of direct treatment of butcher's waste eliminates a step to transform the material into animal flour.

The waste treatment process according to the invention is a particular application of a more general heat treatment principle, namely a process for submitting a divided solid or paste material to a heat treatment (heating or cooling) in order to modify its physical state or its chemical composition, characterised in that the material to be treated enters a containment with reverse current with a mass of steel balls previously heated to a temperature such that the treated material and the mass of balls at the exit from the containment are at the chosen temperature for the heat treatment.

1. Process for the heat treatment of organic waste in which the waste is heated in a fixed or rotating furnace (1), called a thermolysis furnace,
characterised in that
this treatment takes place in an oxygen-free atmosphere, and that
the means of heating the said waste consists of steel balls (3) that move forwards in the thermolysis furnace (1) at the same time as the said waste with which they are intimately mixed.

2. Process according to claim 1, characterised in that the steel balls (3) that form the means for this thermolysis enter the thermolysis furnace (1) at temperatures of between 600° C. and 1100° C. and exit from the furnace at temperatures of between 500° C. and 850° C.

3. Process according to claim 1, characterised in that the balls are heated in a furnace (10) external to the thermolysis furnace (1).

4. Process according to claim 3, characterised in that the furnace (10) is a gas furnace supplied by all or some of thermolysis gases.

5. Process according to claim 3, characterised in that the furnace (10) is an induction furnace.

6. Process according to claim 3, characterised in that the furnace (10) is an electrical furnace.

7. Process according to claim 1, in which the heating mass is composed of 20 mm to 100 mm diameter steel balls (3).

8. Process according to claim 1, in which the heating mass is composed of 20 mm to 50 mm diameter steel balls (3).
